(19) United States
(12) Patent Application Publication
(10) Pub. No.: US 2013/0289844 A1
(43) Pub. Date: Oct. 31, 2013

(54) SMART CRUISE CONTROL SYSTEM AND SMART CRUISE CONTROL METHOD

(71) Applicant: Man Bok Park, Seoul (KR)

(72) Inventor: Man Bok Park, Seoul (KR)

(21) Appl. No.: 13/873,150

(22) Filed: Apr. 29, 2013

(30) Foreign Application Priority Data
Apr. 30, 2012 (KR) 2012-0045056

(51) Int. Cl. B60T 7/22

(52) U.S. Cl. CPC B60T 7/22
USPC 701/70

(57) ABSTRACT

Disclosed herein are a smart cruise control system and a smart cruise control method. The smart cruise control system includes a braking distance calculation unit provided at one side of a vehicle so as to determine a relative speed and distance between vehicles to calculate a braking distance, a road surface detector provided at another side of the vehicle to detect a current road surface condition, a braking distance adjustment unit provided at another side of the vehicle so as to adjust the braking distance calculated by the braking distance calculation unit according to the current road surface condition detected by the road surface detector, and a brake unit provided at another side of the vehicle for braking of the vehicle according to the braking distance adjusted by the braking distance adjustment unit.

### CROSS-REFERENCE TO RELATED APPLICATION(S)

This application claims the benefit of Korean Patent Application No. 2012-0045056, filed on Apr. 30, 2012 in the Korean Intellectual Property Office, the disclosure of which is incorporated herein by reference.

### BACKGROUND

1. Field

Embodiments of the present invention relate to a smart cruise control system and a smart cruise control method.

2. Description of the Related Art

In general, a conventional vehicle is provided in such a way that a driver has to drive the vehicle carefully by checking a road surface condition with the naked eye during driving.

With regard to such a conventional vehicle, a driver has to adjust a braking distance from previous experience according to a current road surface condition during driving. Thus, the driver drives the vehicle inconveniently and unsafely, thereby increasing the likelihood of an accident.

### SUMMARY

Therefore, it is an aspect of the present invention to provide a smart cruise control system and a smart cruise control method, by which a vehicle may brake according to a braking distance optimized based on a current road surface condition, guiding convenient and safe driving to prevent a car accident.

It is another aspect of the present invention to provide a smart cruise control system and a smart cruise control method, by which an adjustment situation of a current braking distance may be indicated in the form of voice, and thus, a situation of a braking distance to be adjusted may be predicted, further guiding convenient and safe driving.

Additional aspects of the invention will be set forth in part in the description which follows and, in part, will be obvious from the description, or may be learned by practice of the invention.

In accordance with one aspect of the present invention, a smart cruise control system includes a braking distance calculation unit provided at one side of a vehicle so as to determine a relative speed and distance between vehicles to calculate a braking distance, a road surface detector provided at another side of the vehicle to detect a current road surface condition, a braking distance adjustment unit provided at another side of the vehicle so as to adjust the braking distance calculated by the braking distance calculation unit according to the current road surface condition detected by the road surface detector, and a brake unit provided at another side of the vehicle for braking of the vehicle according to the braking distance adjusted by the braking distance adjustment unit.

The braking distance adjustment unit may reduce the braking distance calculated by the braking distance calculation unit within a braking distance range corresponding to a reference asymmetric road surface, stored in advance, when the current road surface condition detected by the road surface detector is an asymmetric road surface condition.

The brake unit may increase target deceleration of the vehicle such that the braking distance calculated by the braking distance calculation unit is within the braking distance range corresponding to a reference asymmetric road surface, stored in advance, and may perform braking of the vehicle while the braking distance adjustment unit reduces the braking distance calculated by the braking distance calculation unit within a braking distance range corresponding to the reference asymmetric road surface, when the current road surface condition detected by the road surface detector is an asymmetric road surface condition.

The brake unit may increase target frictional pressure between the vehicle and a road surface such that the braking distance calculated by the braking distance calculation unit is within the braking distance range corresponding to a reference asymmetric road surface, stored in advance, and may perform braking of the vehicle while the braking distance adjustment unit reduces the braking distance calculated by the braking distance calculation unit within a braking distance range corresponding to the reference asymmetric road surface, when the current road surface condition detected by the road surface detector is an asymmetric road surface condition.

The brake unit may include a motor driving power steering (MDPS) module for braking of the vehicle according to the brake distance adjusted by the braking distance adjustment unit.

The smart cruise control system may further include a notification unit provided at another side of the vehicle so as to indicate an adjustment situation of a current braking distance in the form of voice when the braking distance adjustment unit adjusts the braking distance calculated by the braking distance calculation unit, if the current road surface condition detected by the road surface detector is an asymmetric road surface condition.

In accordance with another aspect of the present invention, a smart cruise control method includes calculating a braking distance by providing a braking distance calculation unit at one side of a vehicle so as to determine a relative speed and distance between vehicles, detecting a road surface by providing a road surface detector at another side of the vehicle so as to detect a current road surface condition, adjusting a braking distance by providing a braking distance adjustment unit at another side of the vehicle so as to adjust the braking distance calculated by the braking distance calculation unit according to the current road surface condition detected by the road surface detector, and braking of the vehicle by providing at another side of the vehicle for braking of the vehicle according to the braking distance adjusted by the braking distance adjustment unit.

The adjusting may include reducing the braking distance calculated by the braking distance calculation unit within a braking distance range corresponding to a reference asymmetric road surface, stored in advance, by the braking distance adjustment unit provided at another side of the vehicle, when the current road surface condition detected by the road surface detector is an asymmetric road surface condition.

The braking may include increasing target deceleration of the vehicle such that the braking distance calculated by the braking distance calculation unit is within the braking distance range corresponding to a reference asymmetric road surface, stored in advance, and performing braking of the vehicle by the brake unit provided at another side of the vehicle, while the braking distance adjustment unit reduces the braking distance calculated by the braking distance calculation unit within a braking distance range corresponding to the reference asymmetric road surface, when the current road surface condition detected by the road surface detector is an asymmetric road surface condition.

The braking may include increasing target frictional pressure between the vehicle and a road surface such that the braking distance calculated by the braking distance calculation unit is within the braking distance range corresponding to a reference asymmetric road surface, stored in advance, and performing braking of the vehicle by the brake unit provided at another side of the vehicle, while the braking distance adjustment unit reduces the braking distance calculated by the braking distance calculation unit within a braking distance range corresponding to the reference asymmetric road surface, when the current road surface condition detected by the road surface detector is an asymmetric road surface condition.

The braking may be performed by the brake unit provided at another side of the vehicle, wherein the brake unit may include a motor driving power steering (MDPS) module for braking of the vehicle according to the brake distance adjusted by the braking distance adjustment unit.

The smart cruise control method may further include notifying to indicate an adjustment situation of a current braking distance in the form of voice by a notification unit provided at another side of the vehicle when the braking distance adjustment unit adjusts the braking distance calculated by the braking distance calculation unit, if the current road surface condition detected by the road surface detector is an asymmetric road surface condition.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a block diagram of a smart cruise control system according to a first embodiment of the present invention;

FIG. 2 is a flowchart of a smart cruise control method using the smart cruise control system according to the first embodiment of the present invention;

FIG. 3 is a flowchart of an example of the smart cruise control method using the smart cruise control system according to the first embodiment of the present invention;

FIG. 4 is a flowchart of another example of the smart cruise control method using the smart cruise control system according to the first embodiment of the present invention;

FIG. 5 is a flowchart of another example of the smart cruise control method using the smart cruise control system according to the first embodiment of the present invention;

FIG. 6 is a block diagram of a smart cruise control system according to a second embodiment of the present invention;

FIG. 7 is a flowchart of a smart cruise control method using the smart cruise control system according to the second embodiment of the present invention;

FIG. 8 is a flowchart of an example of the smart cruise control method using the smart cruise control system according to the second embodiment of the present invention;

FIG. 9 is a flowchart of another example of the smart cruise control method using the smart cruise control system according to the second embodiment of the present invention; and

FIG. 10 is a flowchart of another example of the smart cruise control method using the smart cruise control system according to the second embodiment of the present invention.

### DETAILED DESCRIPTION

Reference will now be made in detail to the embodiments of the present invention, examples of which are illustrated in the accompanying drawings.

### First Embodiment

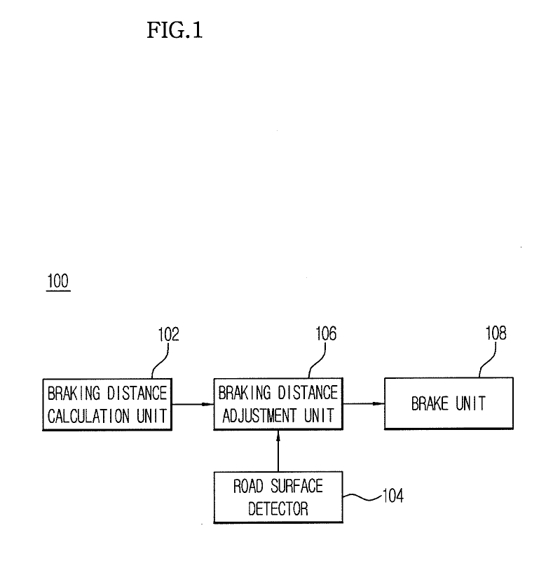

FIG. 1 is a block diagram of a smart cruise control system 100 according to a first embodiment of the present invention.

Referring to FIG. 1, the smart cruise control system 100 according to the first embodiment of the present invention includes a braking distance calculation unit 102, a road surface detector 104, a braking distance adjustment unit 106, and a brake unit 108.

The braking distance calculation unit 102 is provided at one side of a vehicle so as to determine a relative speed and distance between vehicles to calculate a braking distance. The road surface detector 104 is provided at another side of the vehicle to detect a current road surface condition.

The braking distance adjustment unit 106 is provided at another side of the vehicle so as to adjust the braking distance calculated by the braking distance calculation unit 102 according to the current road surface condition detected by the road surface detector 104.

In this case, the braking distance adjustment unit 106 may be provided so as to reduce the braking distance calculated by the braking distance calculation unit 102 within a braking distance range corresponding to a reference asymmetric road surface, which is stored in advance, when the current road surface condition detected by the road surface detector 104 is an asymmetric road surface condition.

The brake unit 108 is provided at another side of the vehicle for braking of the vehicle according to the braking distance adjusted by the braking distance adjustment unit 106.

In this case, when the current road surface condition detected by the road surface detector 104 is the asymmetric road surface condition, while the braking distance adjustment unit 106 reduces the braking distance calculated by the braking distance calculation unit 102 within the braking distance range corresponding to the reference asymmetric road surface, which is stored in advance, the brake unit 108 may increase target deceleration of the vehicle such that the braking distance calculated by the braking distance calculation unit 102 is within the braking distance range corresponding to the reference asymmetric road surface.

Alternatively, when the current road surface condition detected by the road surface detector 104 is the asymmetric road surface condition, while the braking distance adjustment unit 106 reduces the braking distance calculated by the braking distance calculation unit 102 within the braking distance range corresponding to the reference asymmetric road surface, which is stored in advance, the brake unit 108 may increase target frictional pressure between the vehicle and a road surface such that the braking distance calculated by the braking distance calculation unit 102 is within the braking distance range corresponding to the reference asymmetric road surface.

Here, the brake unit 108 may include a motor driving power steering (MDPS) module for braking of the vehicle according to the brake distance adjusted by the braking distance adjustment unit 106.

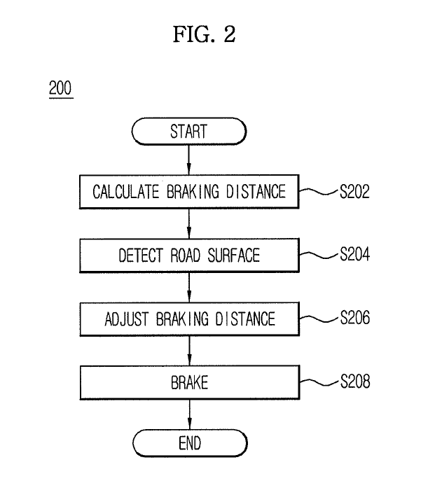

A smart cruise control method using the smart cruise control system 100 according to the first embodiment of the present invention will be described with reference to FIGS. 2 through 5.

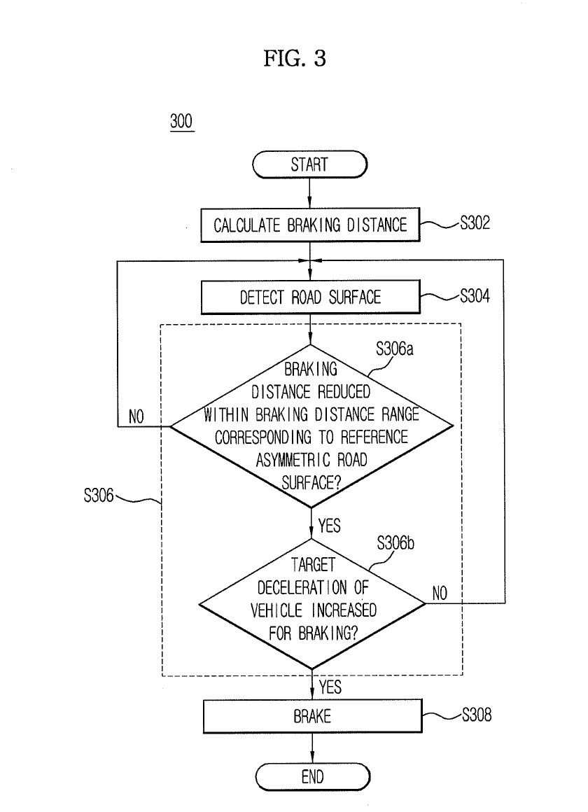

FIG. 2 is a flowchart of a smart cruise control method 200 using the smart cruise control system 100 according to the first embodiment of the present invention and FIG. 3 is a flowchart of an example 300 of the smart cruise control method using the smart cruise control system 100 according to the first embodiment of the present invention.

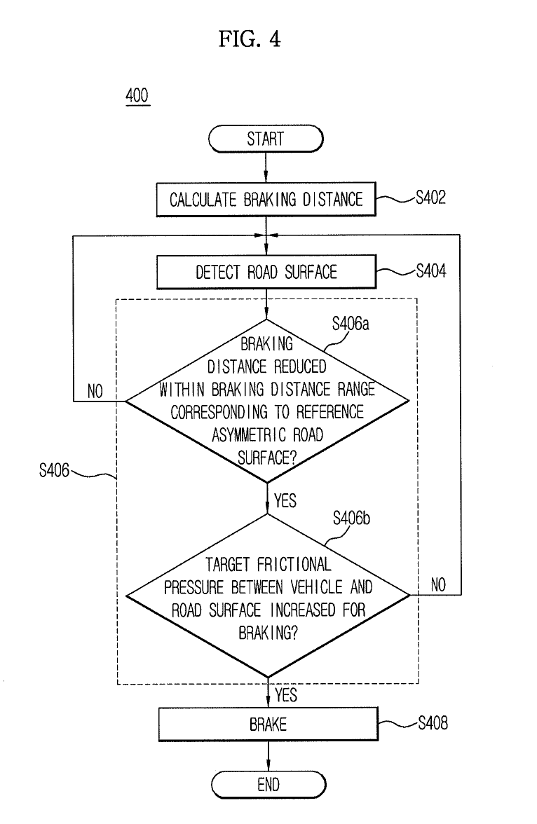

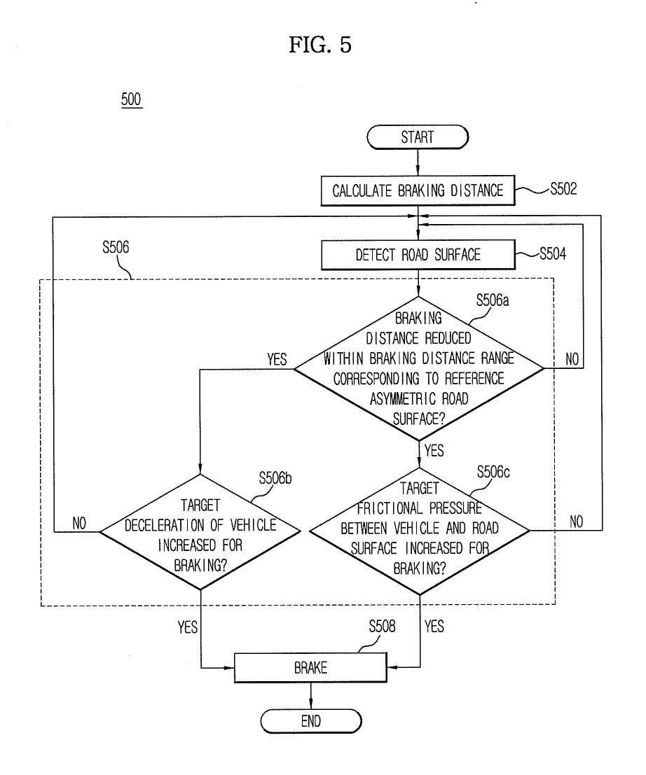

FIG. 4 is a flowchart of another example 400 of the smart cruise control method using the smart cruise control system 100 according to the first embodiment of the present invention and FIG. 5 is a flowchart of another example 500 of the smart cruise control method using the smart cruise control system 100 according to the first embodiment of the present invention.

Referring to FIGS. 2 through 5, according to the first embodiment of the present invention, the smart cruise control methods 200, 300, 400, and 500 include braking distance calculation operations S202, S302, S402, and S502, road surface detection operations S204, S304, S404, and S504, braking distance adjustment operations S206, S306, S406, and S506, and braking operations S208, S308, S408, and S508, respectively.

In the braking distance calculation operations S202, S302, S402, and S502, the braking distance calculation unit 102 (see FIG. 1) is provided at one side of the vehicle and determines the relative speed and distance between vehicles to calculate a braking distance.

Then, in the road surface detection operations S204, S304, S404, and S504, the road surface detector 104 (see FIG. 1) is provided at another side of the vehicle and detects the current road surface condition.

Then, in the braking distance adjustment operations S206, S306, S406, and S506, the braking distance adjustment unit 106 (see FIG. 1) is provided at another side of the vehicle and adjusts the braking distance calculated by the braking distance calculation unit 102 (see FIG. 1) according to the current road surface condition detected by the road surface detector 104 (see FIG. 1).

Here, as illustrated in FIGS. 3 through 5, the braking distance adjustment operations S306, S406, and S506 may respectively include operations S306a, S406a, and S506a in which the braking distance adjustment unit 106 (see FIG. 1) provided at another side of the vehicle reduces the braking distance calculated by the braking distance calculation unit 102 (see FIG. 1) within the braking distance range corresponding to the reference asymmetric road surface, which is stored in advance, when the current road surface condition detected by the road surface detector 104 (see FIG. 1) is the asymmetric road surface condition.

In this case, as illustrated in FIGS. 3 and 5, the braking distance adjustment operations S306 and S506 may respectively include operations S306b and S506b for determination of whether target deceleration of the vehicle is increased such that the braking distance calculated by the braking distance calculation unit 102 (see FIG. 1) is within the braking distance range corresponding to the reference asymmetric road surface, which is stored in advance, while the braking distance adjustment unit 106 (see FIG. 1) reduces the braking distance calculated by the braking distance calculation unit 102 (see FIG. 1) within the braking distance range corresponding to the reference asymmetric road surface when the current road surface condition detected by the road surface detector 104 (see FIG. 1) is the asymmetric road surface condition.

Alternatively, as illustrated in FIGS. 4 and 5, the braking distance adjustment operations S406 and S506 may respectively include operations S406b, and S506c for determination of whether target frictional pressure between the vehicle and a road surface is increased such that the braking distance calculated by the braking distance calculation unit 102 (see FIG. 1) is within the braking distance range corresponding to the reference asymmetric road surface, which is stored in advance, while the braking distance adjustment unit 106 (see FIG. 1) reduces the braking distance calculated by the braking distance calculation unit 102 (see FIG. 1) within the braking distance range corresponding to the reference asymmetric road surface when the current road surface condition detected by the road surface detector 104 (see FIG. 1) is the asymmetric road surface condition.

Lastly, in the braking operations S208, S308, S408, and S508, the brake unit 108 (see FIG. 1) is provided at another side of the vehicle and performs braking of the vehicle according to the braking distance adjusted by the braking distance adjustment unit 106 (see FIG. 1).

Here, in the braking operations S208, S308, S408, and S508, the brake unit 108 (see FIG. 1) is provided at another side of the vehicle and includes a motor driving power steering (MDPS) module for braking of the vehicle according to the brake distance adjusted by the braking distance adjustment unit 106 (see FIG. 1).

In this case, in the braking operations S308, S408, and S508, the brake unit 108 (see FIG. 1) is provided at another side of the vehicle and may increase target deceleration of the vehicle such that the braking distance calculated by the braking distance calculation unit 102 (see FIG. 1) is within the braking distance range corresponding to the reference asymmetric road surface, which is stored in advance, while the braking distance adjustment unit 106 (see FIG. 1) reduces the braking distance calculated by the braking distance calculation unit 102 (see FIG. 1) within the braking distance range corresponding to the reference asymmetric road surface when the current road surface condition detected by the road surface detector 104 (see FIG. 1) is the asymmetric road surface condition.

Alternatively, in the braking operations S308, S408, and S508, the brake unit 108 (see FIG. 1) is provided at another side of the vehicle and may increase target frictional pressure between the vehicle and a road surface such that the braking distance calculated by the braking distance calculation unit 102 (see FIG. 1) is within the braking distance range corresponding to the reference asymmetric road surface, which is stored in advance, while the braking distance adjustment unit 106 (see FIG. 1) reduces the braking distance calculated by the braking distance calculation unit 102 (see FIG. 1) within the braking distance range corresponding to the reference asymmetric road surface when the current road surface condition detected by the road surface detector 104 (see FIG. 1) is the asymmetric road surface condition.

According to the first embodiment of the present invention, the smart cruise control methods 200, 300, 400, and 500 use the smart cruise control system 100 including the braking distance calculation unit 102, the road surface detector 104, the braking distance adjustment unit 106, and the brake unit 108.

Thus, according to the smart cruise control system 100 and smart cruise control methods 200, 300, 400, and 500 according to the first embodiment of the present invention, the vehicle may brake according to a braking distance optimized based on a current road surface condition, guiding convenient and safe driving to prevent a car accident.

### Second Embodiment

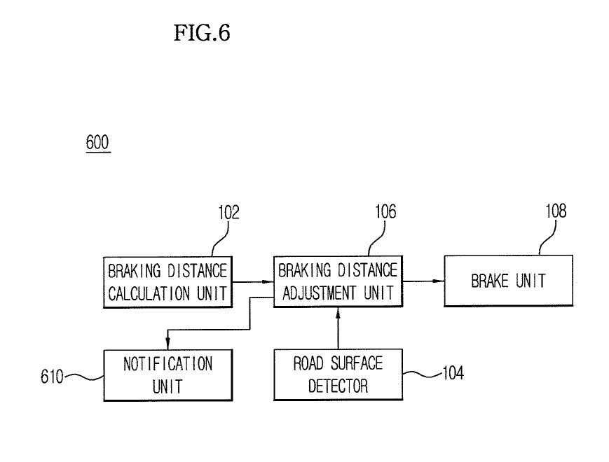

FIG. 6 is a block diagram of a smart cruise control system 600 according to a second embodiment of the present invention.

Referring to FIG. 6, the smart cruise control system 600 according to the second embodiment of the present invention includes the braking distance calculation unit 102, the road surface detector 104, the braking distance adjustment unit 106, the brake unit 108, and a notification unit 610.

The braking distance calculation unit 102 is provided at one side of a vehicle so as to determine a relative speed and distance between vehicles to calculate a braking distance. The road surface detector 104 is provided at another side of the vehicle to detect a current road surface condition.

The braking distance adjustment unit 106 is provided at another side of the vehicle so as to adjust the braking distance calculated by the braking distance calculation unit 102 according to the current road surface condition detected by the road surface detector 104.

In this case, the braking distance adjustment unit 106 may be provided so as to reduce the braking distance calculated by the braking distance calculation unit 102 within a braking distance range corresponding to a reference asymmetric road surface, which is stored in advance, when the current road surface condition detected by the road surface detector 104 is an asymmetric road surface condition.

The brake unit 108 is provided at another side of the vehicle for braking of the vehicle according to the braking distance adjusted by the braking distance adjustment unit 106.

In this case, when the current road surface condition detected by the road surface detector 104 is the asymmetric road surface condition, while the braking distance adjustment unit 106 reduces the braking distance calculated by the braking distance calculation unit 102 within the braking distance range corresponding to the reference asymmetric road surface, which is stored in advance, the brake unit 108 may increase target deceleration of the vehicle such that the braking distance calculated by the braking distance calculation unit 102 is within the braking distance range corresponding to the reference asymmetric road surface.

Alternatively, when the current road surface condition detected by the road surface detector 104 is the asymmetric road surface condition, while the braking distance adjustment unit 106 reduces the braking distance calculated by the braking distance calculation unit 102 within the braking distance range corresponding to the reference asymmetric road surface, which is stored in advance, the brake unit 108 may increase target frictional pressure between the vehicle and a road surface such that the braking distance calculated by the braking distance calculation unit 102 is within the braking distance range corresponding to the reference asymmetric road surface.

Here, the brake unit 108 may include a motor driving power steering (MDPS) module for braking of the vehicle according to the brake distance adjusted by the braking distance adjustment unit 106.

In addition, the notification unit 610 is provided at another side of the vehicle so as to indicate an adjustment situation of a current braking distance in the form of voice when the braking distance adjustment unit 106 adjusts the braking distance calculated by the braking distance calculation unit 102, if the current road surface condition detected by the road surface detector 104 is the asymmetric road surface condition.

In this case, the notification unit 610 may include a vehicle speaker.

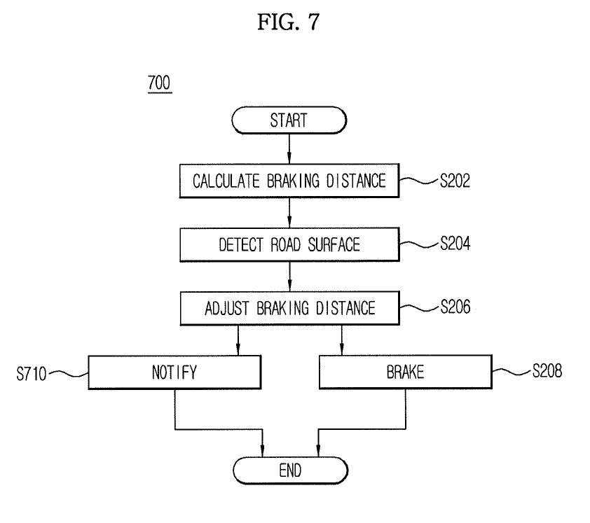

A smart cruise control method using the smart cruise control system 600 according to the second embodiment of the present invention will be described with reference to FIGS. 7 through 10.

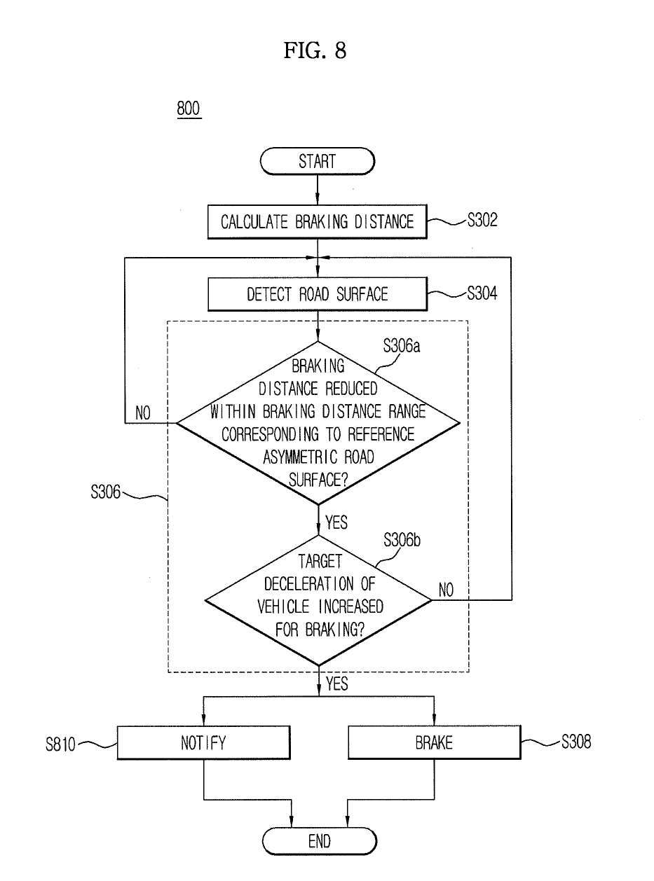

FIG. 7 is a flowchart of a smart cruise control method 700 using the smart cruise control system 600 according to the second embodiment of the present invention and FIG. 8 is a flowchart of an example 800 of the smart cruise control method 700 using the smart cruise control system 600 according to the second embodiment of the present invention.

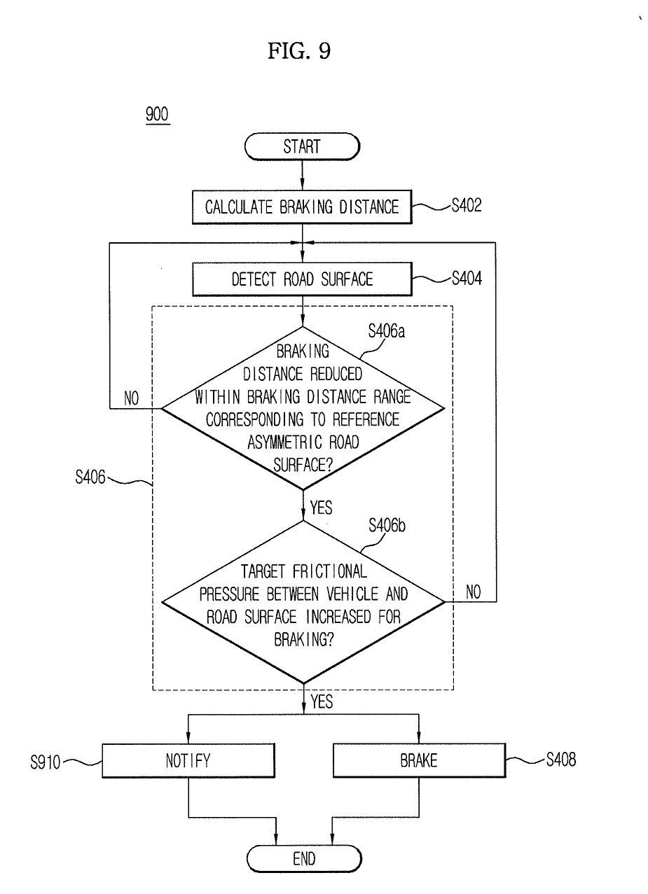

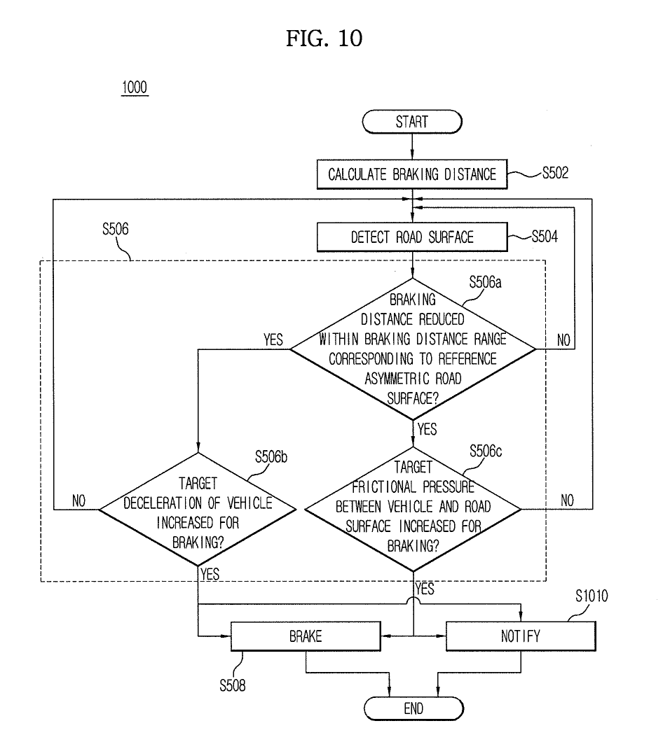

FIG. 9 is a flowchart of another example 900 of the smart cruise control method 700 using the smart cruise control system 600 according to the second embodiment of the present invention and FIG. 10 is a flowchart of another example 1000 of the smart cruise control method 700 using the smart cruise control system 600 according to the second embodiment of the present invention.

Referring to FIGS. 7 through 10, according to the second embodiment of the present invention, the smart cruise control methods 700, 800, 900, and 1000 include braking distance calculation operations S202, S302, S402, and S502, road surface detection operations S204, S304, S404, and S504, braking distance adjustment operations S206, S306, S406, and S506, braking operations S208, S308, S408, and S508, and notification operations S710, S810, S910, and S1010, respectively.

In the braking distance calculation operations S202, S302, S402, and S502, the braking distance calculation unit 102 (see FIG. 6) is provided at one side of the vehicle and determines the relative speed and distance between vehicles to calculate a braking distance.

Then, in the road surface detection operations S204, S304, S404, and S504, the road surface detector 104 (see FIG. 6) is provided at another side of the vehicle and detects the current road surface condition.

Then, in the braking distance adjustment operations S206, S306, S406, and S506, the braking distance adjustment unit 106 (see FIG. 6) is provided at another side of the vehicle and adjusts the braking distance calculated by the braking distance calculation unit 102 (see FIG. 6) according to the current road surface condition detected by the road surface detector 104 (see FIG. 6).

Here, as illustrated in FIGS. 8 through 10, the braking distance adjustment operations S306, S406, and S506 may respectively include operations S306a, S406a, and S506a in which the braking distance adjustment unit 106 (see FIG. 6) provided at another side of the vehicle reduces the braking distance calculated by the braking distance calculation unit 102 (see FIG. 6) within the braking distance range corresponding to the reference asymmetric road surface, which is stored in advance, when the current road surface condition detected by the road surface detector 104 (see FIG. 6) is the asymmetric road surface condition.

In this case, as illustrated in FIGS. 8 and 10, the braking distance adjustment operations S306 and S506 may respectively include operations S306b and S506b for determination of whether target deceleration of the vehicle is increased such that the braking distance calculated by the braking distance calculation unit 102 (see FIG. 6) is within the braking distance range corresponding to the reference asymmetric road surface, which is stored in advance, while the braking distance adjustment unit 106 (see FIG. 6) reduces the braking distance calculated by the braking distance calculation unit 102 (see FIG. 6) within the braking distance range corresponding to the reference asymmetric road surface when the current road surface condition detected by the road surface detector 104 (see FIG. 6) is the asymmetric road surface condition.

Alternatively, as illustrated in FIGS. 9 and 10, the braking distance adjustment operations S406 and S506 may respectively include operations S406b, and S506c for determination of whether target frictional pressure between the vehicle and a road surface is increased such that the braking distance calculated by the braking distance calculation unit 102 (see FIG. 6) is within the braking distance range corresponding to the reference asymmetric road surface, which is stored in advance, while the braking distance adjustment unit 106 (see FIG. 6) reduces the braking distance calculated by the braking distance calculation unit 102 (see FIG. 6) within the braking distance range corresponding to the reference asymmetric road surface when the current road surface condition detected by the road surface detector 104 (see FIG. 6) is the asymmetric road surface condition.

Then, in the notification operations S710, S810, S910, and S1010 performed after the braking distance adjustment operations S206, S306, S406, and S506, the notification unit 610 (see FIG. 6) is provided at another side of the vehicle and indicates an adjustment situation of a current braking distance in the form of voice, when the braking distance adjustment unit 106 (see FIG. 6) adjusts the braking distance calculated by the braking distance calculation unit 102 (see FIG. 6), if the current road surface condition detected by the road surface detector 104 (see FIG. 6) is the asymmetric road surface condition.

Lastly, in the braking operations S208, S308, S408, and S508, the brake unit 108 (see FIG. 6) is provided at another side of the vehicle and performs braking of the vehicle according to the braking distance adjusted by the braking distance adjustment unit 106 (see FIG. 6).

Here, in the braking operations S208, S308, S408, and S508, the brake unit 108 (see FIG. 6) is provided at another side of the vehicle and includes a motor driving power steering (MDPS) module for braking of the vehicle according to the brake distance adjusted by the braking distance adjustment unit 106 (see FIG. 6).

In this case, in the braking operations S308, S408, and S508, the brake unit 108 (see FIG. 6) is provided at another side of the vehicle and may increase target deceleration of the vehicle such that the braking distance calculated by the braking distance calculation unit 102 (see FIG. 6) is within the braking distance range corresponding to the reference asymmetric road surface, which is stored in advance, while the braking distance adjustment unit 106 (see FIG. 6) reduces the braking distance calculated by the braking distance calculation unit 102 (see FIG. 6) within the braking distance range corresponding to the reference asymmetric road surface when the current road surface condition detected by the road surface detector 104 (see FIG. 6) is the asymmetric road surface condition.

Alternatively, in the braking operations S308, S408, and S508, the brake unit 108 (see FIG. 6) is provided at another side of the vehicle, and may increase target frictional pressure between the vehicle and a road surface such that the braking distance calculated by the braking distance calculation unit 102 (see FIG. 6) is within the braking distance range corresponding to the reference asymmetric road surface, which is stored in advance, while the braking distance adjustment unit 106 (see FIG. 6) reduces the braking distance calculated by the braking distance calculation unit 102 (see FIG. 6) within the braking distance range corresponding to the reference asymmetric road surface when the current road surface condition detected by the road surface detector 104 (see FIG. 6) is the asymmetric road surface condition.

According to the second embodiment of the present invention, the smart cruise control methods 700, 800, 900, and 1000 using the smart cruise control system 600 including the braking distance calculation unit 102, the road surface detector 104, the braking distance adjustment unit 106, the brake unit 108, and the notification unit 610.

Thus, according to the smart cruise control system 600 and smart cruise control methods 700, 800, 900, and 1000 according to the second embodiment of the present invention, the vehicle may brake according to a braking distance optimized based on a current road surface condition, guiding convenient and safe driving to prevent a car accident.

According to the smart cruise control system 600 and the smart cruise control methods 700, 800, 900, and 1000 according to the second embodiment of the present invention, an adjustment situation of a current braking distance may be indicated in the form of voice, and thus, a situation of a braking distance to be adjusted may be predicted, further guiding convenient and safe driving.

As is apparent from the above description, a smart cruise control system and a smart cruise control method according to the embodiments of the present invention may have the following effects.

First, a vehicle may brake according to a braking distance optimized based on a current road surface condition, guiding convenient and safe driving to prevent a car accident.

Second, an adjustment situation of a current braking distance may be indicated in the form of voice, and thus, a situation of a braking distance to be adjusted may be predicted, further guiding convenient and safe driving.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A smart cruise control system comprising:
a braking distance calculation unit provided at one side of a vehicle so as to determine a relative speed and distance between vehicles to calculate a braking distance;
a road surface detector provided at another side of the vehicle to detect a current road surface condition;
a braking distance adjustment unit provided at another side of the vehicle so as to adjust the braking distance calculated by the braking distance calculation unit according to the current road surface condition detected by the road surface detector; and
a brake unit provided at another side of the vehicle for braking of the vehicle according to the braking distance adjusted by the braking distance adjustment unit.

2. The smart cruise control system according to claim 1, wherein the braking distance adjustment unit reduces the braking distance calculated by the braking distance calculation unit within a braking distance range corresponding to a reference asymmetric road surface, stored in advance, when the current road surface condition detected by the road surface detector is an asymmetric road surface condition.

3. The smart cruise control system according to claim 1, wherein the brake unit increases target deceleration of the vehicle such that the braking distance calculated by the braking distance calculation unit is within the braking distance range corresponding to a reference asymmetric road surface, stored in advance, and performs braking of the vehicle while the braking distance adjustment unit reduces the braking distance calculated by the braking distance calculation unit within a braking distance range corresponding to the reference asymmetric road surface, when the current road surface condition detected by the road surface detector is an asymmetric road surface condition.

4. The smart cruise control system according to claim 1, wherein the brake unit increases target frictional pressure between the vehicle and a road surface such that the braking distance calculated by the braking distance calculation unit is within the braking distance range corresponding to a reference asymmetric road surface, stored in advance, and performs braking of the vehicle while the braking distance adjustment unit reduces the braking distance calculated by the braking distance calculation unit within a braking distance range corresponding to the reference asymmetric road surface, when the current road surface condition detected by the road surface detector is an asymmetric road surface condition.

5. The smart cruise control system according to claim 1, wherein the brake unit comprises a motor driving power steering (MDPS) module for braking of the vehicle according to the brake distance adjusted by the braking distance adjustment unit.

6. The smart cruise control system according to claim 1, further comprising a notification unit provided at another side of the vehicle so as to indicate an adjustment situation of a current braking distance in the form of voice when the braking distance adjustment unit adjusts the braking distance calculated by the braking distance calculation unit, if the current road surface condition detected by the road surface detector is an asymmetric road surface condition.

7. A smart cruise control method comprising:
calculating a braking distance by providing a braking distance calculation unit at one side of a vehicle so as to determine a relative speed and distance between vehicles;
detecting a road surface by providing a road surface detector at another side of the vehicle so as to detect a current road surface condition;
adjusting a braking distance by providing a braking distance adjustment unit at another side of the vehicle so as to adjust the braking distance calculated by the braking distance calculation unit according to the current road surface condition detected by the road surface detector; and
braking of the vehicle by providing at another side of the vehicle for braking of the vehicle according to the braking distance adjusted by the braking distance adjustment unit.

8. The smart cruise control method according to claim 7, wherein the adjusting comprises reducing the braking distance calculated by the braking distance calculation unit within a braking distance range corresponding to a reference asymmetric road surface, stored in advance, by the braking distance adjustment unit provided at another side of the vehicle, when the current road surface condition detected by the road surface detector is an asymmetric road surface condition.

9. The smart cruise control method according to claim 7, wherein the braking comprises increasing target deceleration of the vehicle such that the braking distance calculated by the braking distance calculation unit is within the braking distance range corresponding to a reference asymmetric road surface, stored in advance, and performing braking of the vehicle by the brake unit provided at another side of the vehicle, while the braking distance adjustment unit reduces the braking distance calculated by the braking distance calculation unit within a braking distance range corresponding to the reference asymmetric road surface, when the current road surface condition detected by the road surface detector is an asymmetric road surface condition.

10. The smart cruise control method according to claim 7, wherein the braking comprises increasing target frictional pressure between the vehicle and a road surface such that the braking distance calculated by the braking distance calculation unit is within the braking distance range corresponding to a reference asymmetric road surface, stored in advance, and performing braking of the vehicle by the brake unit provided at another side of the vehicle, while the braking distance adjustment unit reduces the braking distance calculated by the braking distance calculation unit within a braking distance range corresponding to the reference asymmetric road surface, when the current road surface condition detected by the road surface detector is an asymmetric road surface condition.

11. The smart cruise control method according to claim 7, wherein the braking is performed by the brake unit provided at another side of the vehicle, wherein the brake unit comprises a motor driving power steering (MDPS) module for braking of the vehicle according to the brake distance adjusted by the braking distance adjustment unit.

12. The smart cruise control method according to claim 7, further comprising notifying to indicate an adjustment situation of a current braking distance in the form of voice by a notification unit provided at another side of the vehicle when the braking distance adjustment unit adjusts the braking distance calculated by the braking distance calculation unit, if the current road surface condition detected by the road surface detector is an asymmetric road surface condition.
